(19) United States
(12) Patent Application Publication
(10) Pub. No.: US 2014/0359000 A1
(43) Pub. Date: Dec. 4, 2014

(54) METHOD FOR REMOTELY ASSISTING USER IN SETTING UTILITY PROGRAM

(71) Applicant: DynaLab (Singapore) Ltd., Singapore (SG)

(72) Inventor: Han-Hong LIN, Fenglin Township (TW)

(73) Assignee: DYNALAB (SINGAPORE) LTD., Singapore (SG)

(21) Appl. No.: 14/293,287

(22) Filed: Jun. 2, 2014

(30) Foreign Application Priority Data
Jun. 4, 2013 (TW) 102119742

(51) Int. Cl. H04L 29/08

(52) U.S. Cl. CPC H04L 67/10
USPC 709/203

(57) ABSTRACT

The present invention is to provide a method for remotely assisting a user in setting a utility program, which is applicable to a network system including an electronic device (e.g., a smartphone, or a tablet computer) storing plural entries of client-end setting data and a cloud server storing plural entries of server-end setting data each corresponding to one entry of the client-end setting data. The method is performed by the cloud server and includes the steps of activating a server-end program to connect with the electronic device via the Internet; adjusting an entry of the server-end setting data according to an edit command received from a client; sending the adjusted server-end setting data to the electronic device via the Internet so that the electronic device can reset the corresponding entry of the client-end setting data and display the corresponding utility program installed therein according to the adjusted server-end setting data.

### FIELD OF THE INVENTION

The present invention is to provide a method for remotely assisting a user in setting a utility program, which is applicable to a network system including an electronic device and a cloud server, so that when the user is unfamiliar with the way of setting a utility program in the electronic device, he or she can directly contact a remote service representative of the cloud server (e.g., by phone or by other network communication means) in order for the service representative to generate an edit command through the Internet for enabling the cloud server to set the utility program in the electronic device accordingly.

### BACKGROUND OF THE INVENTION

With the advancement of microelectronics and the rapid development of the technological industry, the market has been supplied with a great variety of electronic devices for consumers to choose from according to their preferences and needs. In addition to such well-known devices as notebook computers and personal digital assistants (PDAs), recent years have seen the prevalence of smartphones, tablet computers, and ultrabook computers. These electronic devices typically feature “high portability”, “ease of operation”, and “versatility” as their selling points, and because of that, many program developers have designed special application program functions or user interfaces for them in order to provide enhanced user experience.

“Widgets”, for instance, are one of those extensively used utility programs. Also known as an application program component, an application program gadget, an information tool window, a dedicated interface tool, a client-end on-demand tool, or a mini application program, a widget is, in short, a small tool capable of presenting user-defined personalized information (e.g., weather forecasts, stock exchange information, emails, calendars, or news) through a specific platform (e.g., a widget engine). In the current Android smartphone operating systems, for example, many applications (or better known as APPs) have corresponding widgets. A smartphone user may put widgets of specific functions into the home screen (the so-called wallpaper) in order to obtain the desired information or access the most frequently used services (e.g., real-time international news or the music most frequently listened to) as soon as the smartphone is turned on.

However, the user is required to set the widgets according to his or her own needs; otherwise, the widgets cannot work properly, despite their versatility. For those who are not quite familiar with the operation of electronic devices (e.g., the elderly), though, the setting process of a widget can be extremely complicated and far from intuitive. The setting of such details as the display shape, size, location, and palette of a widget is oftentimes a source of frustration to the user during the setting process, if not adversely affecting the user's impression of electronic products in general.

In light of the above, the inventor of the present invention came up with the idea of providing a method which incorporates the far-reaching Internet and by which anyone baffled at the setting of a widget can contact a service representative of a service provider by phone or by other network communication means in order to solve the problem at hand immediately. The issue to be addressed by the present invention, therefore, is to specifically define the process flow and related conditions of such a method.

### BRIEF SUMMARY OF THE INVENTION

In view of the fact that the setting of a utility program, such as a widget, can be a daunting experience, the inventor of the present invention put years of practical experience into repeated tests and improvements and finally succeeded in designing a method for remotely assisting a user in setting a utility program. The method is intended to provide real-time on-line solution to a utility program user's various problems through the Internet.

It is an object of the present invention to provide a method for remotely assisting a user in setting a utility program. The method is applicable to a network system which includes an electronic device (e.g., a smartphone, a tablet computer, or a television screen) and a cloud server. The electronic device includes a first processing unit, a first communication unit, a first storage unit, and a first display unit. The first communication unit is configured to connect to the Internet. The first storage unit is installed with a client-end program and a plurality of utility programs (e.g., widgets, APPs, or other application programs). The first storage unit is further provided with a client-end database which stores plural entries of client-end setting data. Each entry of the client-end setting data corresponds to one of the utility programs so that the first processing unit can display each utility program on the first display unit according to the corresponding entry of the client-end setting data (e.g., settings as to whether a particular widget should be displayed and as to the appearance and display location of that widget when displayed). The cloud server includes a second processing unit, a second communication unit, and a second storage unit. The second communication unit is configured to connect to the Internet. The second storage unit is installed with a server-end program and is provided with a server-end database. The server-end database stores plural entries of server-end setting data, wherein each entry of the server-end setting data corresponds to one entry of the client-end setting data. The method includes the following steps to be performed by the second processing unit of the cloud server: activating the server-end program and connecting with the electronic device via the second communication unit and the Internet; adjusting an entry of the server-end setting data according to an edit command after the cloud server receives the edit command (which is, for example, given by the user by telephone or other network communication means); sending the adjusted server-end setting data to the electronic device via the server-end program and the Internet so that the electronic device can, upon receiving the adjusted server-end setting data, reset the corresponding entry of the client-end setting data according to the adjusted server-end setting data and display the corresponding utility program on the first display unit according to the reset client-end setting data. The method of the present invention is so designed that, if the user is unfamiliar with the way in which the utility programs should be set, he or she can directly contact a remote service representative of the cloud server (e.g., by phone or by other network communication means) in order for the service representative to generate the edit command through the Internet, and for the electronic device to set the utility programs for the user according to the user's practical needs.

Another object of the present invention is to provide the foregoing method, wherein the client-end database further stores a server list (e.g., a name and a password of a telecommunication service provider). Once the cloud server activates the server-end program, the second processing unit of the cloud server sends verification data to the electronic device via the second communication unit and the Internet. Only after the electronic device determines that the verification data match the server list can the cloud server connect with the electronic device.

### BRIEF DESCRIPTION OF THE SEVERAL VIEWS OF THE DRAWINGS

The technical features, steps, and objects of the present invention will be best understood by referring to the following detailed description of some illustrative embodiments in conjunction with the accompanying drawings, in which:

FIG. 1 is a schematic drawing of a network system to which the method of the present invention can be applied;

FIG. 2 is a schematic drawing of a screen image of an electronic device before the screen image is changed;

FIG. 3 is the flowchart of the first preferred embodiment of the method of the present invention;

FIG. 4 is a schematic drawing of a screen image of an electronic device, wherein the screen image has been changed; and

FIG. 5 is a schematic drawing of the server-end control interface in the method of the present invention.

### DETAILED DESCRIPTION OF THE INVENTION

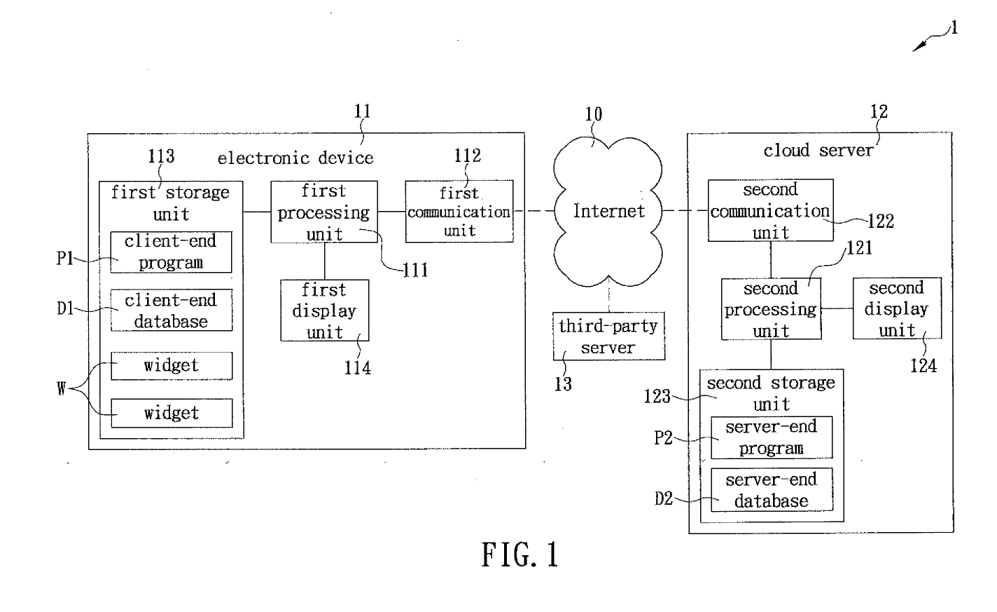

The present invention discloses a method for remotely assisting a user in setting a utility program. Referring to FIG. 1 for a schematic drawing of a network system to which the disclosed method can be applied, the network system 1 includes an electronic device 11 and a cloud server 12. The electronic device 11 may be a smartphone or a tablet computer and is provided with a first processing unit 111, a first communication unit 112, a first storage unit 113, and a first display unit 114. The first communication unit 112 is configured to connect to the Internet 10. The first storage unit 113 is installed with a client-end program P1, a plurality of utility programs (e.g., the aforesaid widgets) W, and a client-end database D1.

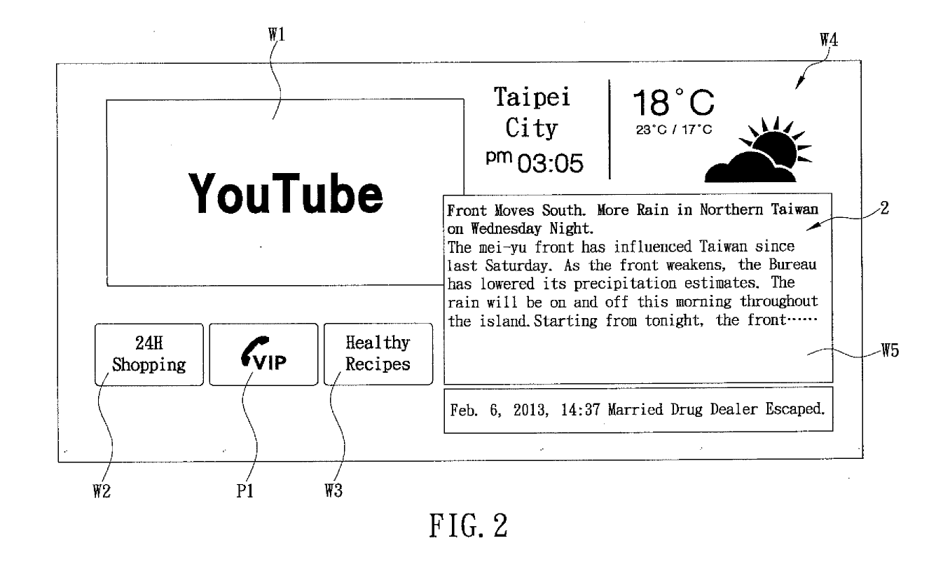

Referring to FIG. 1 and FIG. 2, the client-end database D1 stores a server list and plural entries of client-end setting data. The server list includes a name and a password (e.g., of a telecommunication service provider) which are approved and trusted by the user. Each entry of the client-end setting data corresponds to one of the widgets W so that the first processing unit 111 can display each widget W on the first display unit 114 according to the corresponding entry of the client-end setting data. FIG. 2 shows an example of the screen images displayed by the first display unit 114. In this example, the first display unit 114 displays a total of five widgets, including a video widget W1, a shopping widget W2, a recipe widget W3, a weather widget W4, and a news widget W5.

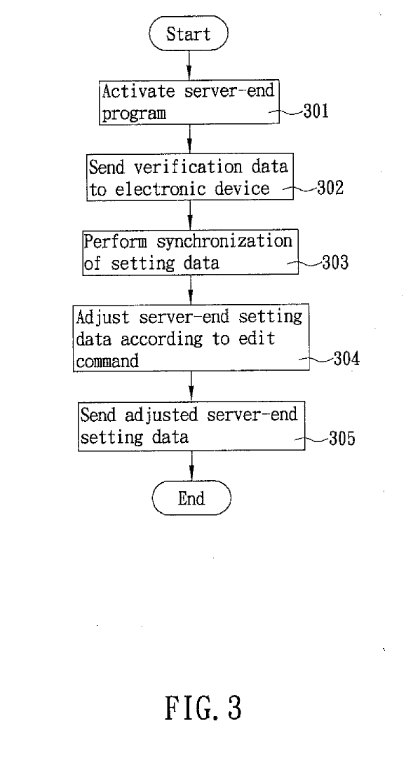

The cloud server 12 includes a second processing unit 121, a second communication unit 122, a second storage unit 123, and a second display unit 124. The second communication unit 122 is configured to connect to the Internet 10. The second storage unit 123 is installed with a server-end program P2 and a server-end database D2. Referring to FIG. 1 to FIG. 3, when the user of the electronic device 11 is dissatisfied with the settings of any of the widgets W and wishes to made adjustments, he or she can activate the client-end program P1 in order to search for the cloud server 12 through the Internet 10 and contact a service representative who can remotely instruct the user in setting the widget W. (In this embodiment, the electronic device 11 and the cloud server 12 are capable of enabling voice communication therebetween through the client-end program P1 and the server-end program P2; however, the user may contact a service representative by phone or by other network communication services instead.) The processing steps of the second processing unit 121 of the cloud server 12 are as follows:

(301) The second processing unit 121 activates the server-end program P2 and searches for the electronic device 11 via the second communication unit 122 and the Internet 10. (It is also feasible for the electronic device 11 to take the initiative and search for the cloud server 12.)

(302) Once the electronic device 11 is found, the second processing unit 121 sends verification data to the electronic device 11. The cloud server 12 cannot connect with the electronic device 11 unless the first processing unit 111 determines that the verification data match the server list.

(303) After the connection is established, the second processing unit 121 performs synchronization of the client-end setting data. More specifically, the second processing unit 121 sends a synchronization command to the electronic device 11 through the server-end program P2, requesting to receive and save the plural entries of the client-end setting data in the electronic device 11. (Alternatively, the first processing unit 111 may take the initiative and send the client-end setting data to the cloud server 12 through the client-end program P1). Then, the second processing unit 121 adds each entry of the client-end setting data to the server-end database D2 as an entry of server-end setting data.

(304) After the user makes his or her needs known to the service representative of the cloud server 12, the service representative inputs the corresponding edit command via the Internet 10 in order for the second processing unit 121 to adjust the corresponding entry of the server-end setting data according to the edit command.

(305) Lastly, the second processing unit 121 sends the adjusted server-end setting data to the electronic device 11 through the server-end program P2 and the Internet 10. The electronic device 11 receives the adjusted server-end setting data, resets the corresponding client-end setting data according to the adjusted server-end setting data, and displays the corresponding widget(s) W on the first display unit 114 according to the reset client-end setting data.

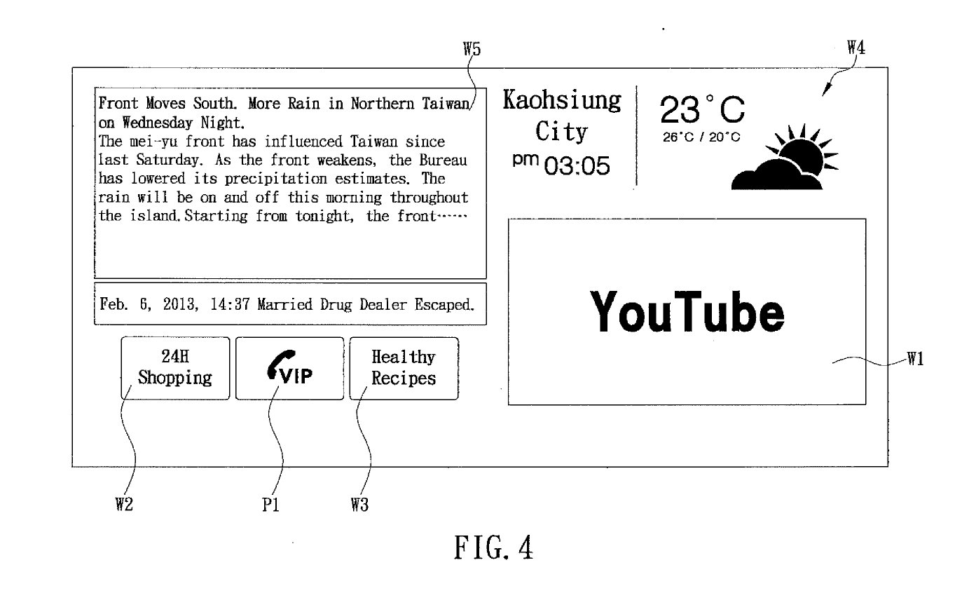

Referring to FIG. 1 and FIG. 2, assume the initial screen image of the electronic device 11 is as shown in FIG. 2, and the user wishes to adjust the locations of the video widget W1 and the news widget W5 and the forecast city in the weather widget W4. The user only has to contact a service representative and make his or her needs clear, and the service representative can either make corresponding adjustments on-line immediately for the user or explain the setting procedure to the user while allowing the user to see at once if the changes made by the service representative meet the user's expectations (as shown in FIG. 4). Thus, the ease of use of the electronic device 11 is significantly increased, which in turn may increase the user's willingness to use the electronic device 11. In addition, each entry of the client-end setting data in the present embodiment may be divided into activation data, location data, and appearance data. The activation data are used to set whether a particular widget W should be displayed (e.g., to be displayed or hidden). The location data are used to set the location where a particular widget W is to be displayed on the first display unit 114 (e.g., on the left or on the right). The appearance data are used to set the appearance (e.g., the colors or size) of a particular widget W when the widget W is displayed on the first display unit 114. Upon determining that the aforesaid data in the client-end setting data are changed, the first processing unit 111 of the electronic device 11 sends a synchronization command to the cloud server 12 through the client-end program P1 and the Internet 10 in order for the cloud server 12 to receive all the changed client-end setting data according to the synchronization command and thereby update the corresponding server-end setting data. Thus, not only can the user practice how to make the settings under the service representative's oral instructions, but also the service representative can know in real time whether the user operates correctly.

Moreover, if the widgets W are those designed to show specific data, such as a weather widget, a news widget, a stock exchange information widget, and so on, each entry of the client-end setting data may further include category data (e.g., the category/categories of the news of interest, the specific company/companies whose stock exchange information is of interest, or the specific city/cities whose weather is of interest). When executing a particular widget W, the first processing unit 111 of the electronic device 11 can receive display data from a third-party server 13 (e.g., the news server of Yahoo or Google, or the weather server of the Central Weather Bureau of Taiwan) according to the corresponding category data and display the display data on the first display unit 114. For example, the weather forecast “Front Moves South . . . ” in the news widget W5 in FIG. 2 is the display data 2 in the corresponding entry of the client-end setting data.

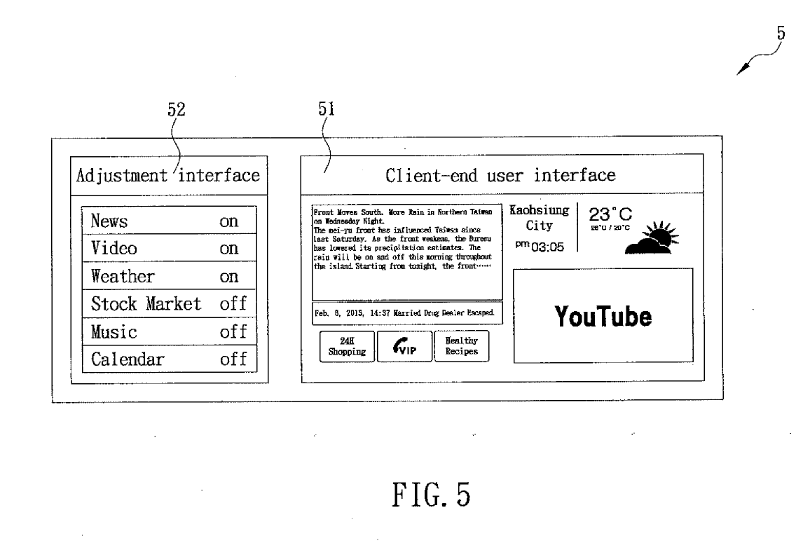

Further, referring to FIG. 1 and FIG. 5, in order for a service representative to know the current screen image of the electronic device 11 in real time and provide instructions to the user through the Internet 10 simultaneously, the second processing unit 121 generates a server-end control interface 5 on the second display unit 124 via the server-end program P2 after adding the client-end setting data and saving them as the server-end setting data. The server-end control interface 5 at least includes a client-end user interface 51 and an adjustment interface 52. The client-end user interface 51 enables the second processing unit 121 to display a simulated screen image of the first display unit 114 on the second display unit 124 according to the server-end setting data.

The adjustment interface 52, on the other hand, enables the second processing unit 121 to display on the second display unit 124 the server-end setting data corresponding to the widgets W, thereby enabling a service representative to make real-time adjustments. Once the service representative inputs an edit command (e.g., to adjust the location of a particular widget W) through the adjustment interface, the client-end user interface 51 is adjusted simultaneously. In the meantime, the cloud server 12 sends the adjusted server-end setting data to the electronic device 11 in order for the user to see in real time the result of the service representative's operation. Thus, a convenient operation platform is provided through which the user and the service representative can communicate easily with each other. It should be pointed out that, while the adjustment interface 52 in FIG. 5 only shows the on or off of each widget W, the adjustment interface 52 in another embodiment of the present invention may include more operating options. FIG. 5 is a schematic drawing by way of example only.

While the invention herein disclosed has been described by means of specific embodiments, numerous modifications and variations could be made thereto by those skilled in the art without departing from the scope of the invention set forth in the claims.

What is claimed is:

1. A method for remotely assisting a user in setting a utility program, the method being applicable to a network system, the network system including an electronic device and a cloud server, the electronic device being provided with a first processing unit, a first communication unit, a first storage unit, and a first display unit, the first communication unit being configured to connect to the Internet, the first storage unit being installed with a client-end program and a plurality of utility programs, the first storage unit also being provided with a client-end database, the client-end database storing plural entries of client-end setting data, each entry of the client-end setting data corresponding to a said utility program so that the first processing unit can display each said utility program on the first display unit according to a corresponding entry of the client-end setting data, the cloud server including a second processing unit, a second communication unit, and a second storage unit, the second communication unit being configured to connect to the Internet, the second storage unit being installed with a server-end program and provided with a server-end database, the server-end database storing plural entries of server-end setting data, each entry of the server-end setting data corresponding to an entry of the client-end setting data, the method comprising the steps, to be performed by the second processing unit of the cloud server, of:
activating the server-end program, and connecting with the electronic device through the second communication unit and the Internet;
adjusting an entry of the sever-end setting data according to an edit command after the cloud server receives the edit command; and
sending the adjusted server-end setting data to the first communication unit through the server-end program and the Internet in order for the electronic device to reset a corresponding entry of the client-end setting data according to the adjusted server-end setting data and display a corresponding said utility program on the first display unit according to a reset appearance and a reset display location of the corresponding utility program.

2. The method of claim 1, further comprising the steps, to be performed by the second processing unit when the cloud server is connected with the electronic device, of:
sending a synchronization command to the electronic device through the server-end program and the second communication unit, thereby requesting to receive the plural entries of the client-end setting data in the electronic device; and
resetting each entry of the server-end setting data according to a corresponding entry of the client-end setting data in order to ensure the server-end setting data match the client-end setting data.

3. The method of claim 1, wherein when the cloud server is connected with the electronic device, the electronic device proactively sends the plural entries of the client-end setting data to the cloud server through the client-end program and the first communication unit in order for the second processing unit to reset each entry of the server-end setting data according to a corresponding entry of the client-end setting data, thereby ensuring the server-end setting data match the client-end setting data.

4. The method of claim 1, wherein each entry of the client-end setting data comprises activation data, location data, and appearance data, the activation data being used to set whether a corresponding said utility program should be displayed, the location data being used to set a display location of the corresponding utility program on the first display unit, the appearance data being used to set an appearance of the corresponding utility program when the corresponding utility program is displayed on the first display unit; and wherein upon determining that an entry of the client-end setting data is changed, the first processing unit sends a synchronization command to the cloud server through the client-end program and the Internet in order for the cloud server to update a corresponding entry of the server-end setting data.

5. The method of claim 2, wherein each entry of the client-end setting data comprises activation data, location data, and appearance data, the activation data being used to set whether a corresponding said utility program should be displayed, the location data being used to set a display location of the corresponding utility program on the first display unit, the appearance data being used to set an appearance of the corresponding utility program when the corresponding utility program is displayed on the first display unit; and wherein upon determining that an entry of the client-end setting data is changed, the first processing unit sends a synchronization command to the cloud server through the client-end program and the Internet in order for the cloud server to update a corresponding entry of the server-end setting data.

6. The method of claim 3, wherein each entry of the client-end setting data comprises activation data, location data, and appearance data, the activation data being used to set whether a corresponding said utility program should be displayed, the location data being used to set a display location of the corresponding utility program on the first display unit, the appearance data being used to set an appearance of the corresponding utility program when the corresponding utility program is displayed on the first display unit; and wherein upon determining that an entry of the client-end setting data is changed, the first processing unit sends a synchronization command to the cloud server through the client-end program and the Internet in order for the cloud server to update a corresponding entry of the server-end setting data.

7. The method of claim 4, wherein each entry of the client-end setting data further comprises category data so that, when executing a said utility program, the first processing unit can receive display data from a third-party server according to corresponding said category data and display the display data on the first display unit.

8. The method of claim 5, wherein each entry of the client-end setting data further comprises category data so that, when executing a said utility program, the first processing unit can receive display data from a third-party server according to corresponding said category data and display the display data on the first display unit.

9. The method of claim 6, wherein each entry of the client-end setting data further comprises category data so that, when executing a said utility program, the first processing unit can receive display data from a third-party server according to corresponding said category data and display the display data on the first display unit.

10. The method of claim 7, wherein the client-end database further stores a server list, and the method further comprises the step, to be performed by the second processing unit after the cloud server activates the server-end program, of sending verification data to the electronic device through the second communication unit and the Internet, the cloud server connecting with the electronic device only after the first processing unit of the electronic device determines that the verification data match the server list.

11. The method of claim 8, wherein the client-end database further stores a server list, and the method further comprises the step, to be performed by the second processing unit after the cloud server activates the server-end program, of sending verification data to the electronic device through the second communication unit and the Internet, the cloud server connecting with the electronic device only after the first processing unit of the electronic device determines that the verification data match the server list.

12. The method of claim 9, wherein the client-end database further stores a server list, and the method further comprises the step, to be performed by the second processing unit after the cloud server activates the server-end program, of sending verification data to the electronic device through the second communication unit and the Internet, the cloud server connecting with the electronic device only after the first processing unit of the electronic device determines that the verification data match the server list.

13. The method of claim 10, wherein the cloud server further includes a second display unit, and the method further comprises the step, to be performed by the second processing unit after the cloud server stores the plural entries of the server-end setting data, of generating a server-end control interface on the second display unit through the server-end program, the server-end control interface comprising a client-end user interface and an adjustment interface, the client-end user interface enabling the second processing unit to display a simulated screen image of the first display unit on the second display unit according to the plural entries of the server-end setting data, the adjustment interface enabling the second processing unit to display on the second display unit the server-end setting data corresponding to the utility programs.

14. The method of claim 11, wherein the cloud server further includes a second display unit, and the method further comprises the step, to be performed by the second processing unit after the cloud server stores the plural entries of the server-end setting data, of generating a server-end control interface on the second display unit through the server-end program, the server-end control interface comprising a client-end user interface and an adjustment interface, the client-end user interface enabling the second processing unit to display a simulated screen image of the first display unit on the second display unit according to the plural entries of the server-end setting data, the adjustment interface enabling the second processing unit to display on the second display unit the server-end setting data corresponding to the utility programs.

15. The method of claim 12, wherein the cloud server further includes a second display unit, and the method further comprises the step, to be performed by the second processing unit after the cloud server stores the plural entries of the server-end setting data, of generating a server-end control interface on the second display unit through the server-end program, the server-end control interface comprising a client-end user interface and an adjustment interface, the client-end user interface enabling the second processing unit to display a simulated screen image of the first display unit on the second display unit according to the plural entries of the server-end setting data, the adjustment interface enabling the second processing unit to display on the second display unit the server-end setting data corresponding to the utility programs.
